(19) United States
(12) Patent Application Publication
(10) Pub. No.: US 2016/0288340 A1
(43) Pub. Date: Oct. 6, 2016

(54) ROBOT SYSTEM

(71) Applicant: Seiko Epson Corporation, Tokyo (JP)

(72) Inventors: Kazushige AKAHA, Azumino (JP); Kazuto YOSHIMURA, Matsumoto (JP)

(21) Appl. No.: 15/079,301

(22) Filed: Mar. 24, 2016

(30) Foreign Application Priority Data
Mar. 31, 2015 (JP) 2015-071199

(51) Int. Cl. B25J 21/00; B25J 17/00; B25J 18/04

(52) U.S. Cl. CPC B25J 21/00; B25J 18/04; B25J 17/00

(57) ABSTRACT

A robot system includes a cell having a first surface at an angle different from that of a horizontal plane, and a robot provided on the first surface, wherein the robot has an nth (n is an integer number equal to or more than one) arm rotatable about an nth rotation shaft, and an (n+1)th arm provided on the nth arm rotatably about an (n+1)th rotation shaft in a shaft direction different from a shaft direction of the nth rotation shaft.

### BACKGROUND

1. Technical Field

The present invention relates to a robot system.

2. Related Art

In related art, robots with robot arms are known. In the robot arm, a plurality of arms (arm members) are coupled via joint parts and, as an end effector, e.g. a hand is attached to the arm on the most distal end side (on the most downstream side). The joint parts are driven by motors and the arms rotate by driving of the joint parts. Then, for example, the robot grasps an object with the hand, moves the object to a predetermined location, and performs predetermined work such as assembly.

Further, Patent Document 1 (JP-A-2011-21874) discloses a robot cell having a cell and a robot provided within the cell. In the robot cell described in Patent Document 1, the robot is installed on a surface in parallel to the horizontal plane, i.e., a ceiling surface of the cell.

However, in the robot cell described in Patent Document 1, when the robot is installed on the ceiling surface, there is a problem that the position of the center of gravity of the robot is higher and, if the robot vibrates, the influence of the vibration is larger.

Or, when the robot is installed on the floor surface, there is a problem that the robot itself is an obstacle and workability is worse.

### SUMMARY

An advantage of some aspects of the invention is to solve at least a part of the problems described above, and the invention can be implemented as the following forms and application examples.

### Application Example 1

A robot system according to this application example of the invention includes a cell having a first surface at an angle different from that of a horizontal plane, and a robot provided on the first surface, wherein the robot has an nth (n is an integer number equal to or more than one) arm rotatable about an nth rotation shaft, and an (n+1)th arm provided on the nth arm rotatably about an (n+1)th rotation shaft in a shaft direction different from a shaft direction of the nth rotation shaft.

With this configuration, when the first surface is e.g. a wall surface at the angle different from that of the horizontal plane, the position of the center of gravity of the robot is lower and the influence of the vibration of the robot may be made smaller than those in the case where the robot is installed on the ceiling surface. Further, the robot itself being an obstacle may be suppressed, and workability of the robot within the cell may be improved.

### Application Example 2

In the robot system according to the application example of the invention, it is preferable that the first surface is perpendicular to the horizontal plane.

With this configuration, when the first surface is e.g. a wall surface perpendicular to the horizontal plane, the position of the center of gravity of the robot is lower and the influence of the vibration of the robot may be made smaller than those in the case where the robot is installed on the ceiling surface. Further, the robot itself being an obstacle may be suppressed, and workability of the robot within the cell may be improved.

### Application Example 3

In the robot system according to the application example of the invention, it is preferable that the first surface is tilted with respect to the horizontal plane.

With this configuration, as seen from the shaft direction of the nth rotation shaft, the distal end of the (n+1)th arm may be moved to a farther position from the nth rotation shaft.

Further, when the first surface is e.g. a wall surface tilted with respect to the horizontal plane, the position of the center of gravity of the robot is lower and the influence of the vibration of the robot may be made smaller than those in the case where the robot is installed on the ceiling surface. Further, the robot itself being an obstacle may be suppressed, and workability of the robot within the cell may be improved.

### Application Example 4

In the robot system according to the application example of the invention, it is preferable that a length of the nth arm is longer than a length of the (n+1)th arm, and the nth arm and the (n+1)th arm can overlap as seen from the shaft direction of the (n+1)th rotation shaft.

With this configuration, the space for preventing the robot from interfering may be made smaller when the distal end of the (n+1)th arm is moved to a position different by 180° about the nth rotation shaft. Therefore, the cell may be downsized and the installation space for installation of the robot system may be made smaller.

### Application Example 5

In the robot system according to the application example of the invention, it is preferable that an installation area of the robot cell is less than 637500 mm².

The space for preventing the robot from interfering may be made smaller when the distal end of the (n+1)th arm is moved to a position different by 180° about the nth rotation shaft, and thus, the interference between the robot and the cell in the movement may be prevented even in the installation area.

With this configuration, the installation space for installation of the robot system may be made smaller.

### Application Example 6

In the robot system according to the application example of the invention, it is preferable that an installation area of the robot cell is equal to or less than 500000 mm².

The space for preventing the robot from interfering may be made smaller when the distal end of the (n+1)th arm is moved to a position different by 180° about the nth rotation shaft, and thus, the interference between the robot and the cell in the movement may be prevented even in the installation area.

With this configuration, the installation space for installation of the robot system may be made smaller.

### Application Example 7

In the robot system according to the application example of the invention, it is preferable that the robot has a base provided on the first surface, and the n is one and the nth arm is provided on the base.

With this configuration, the robot that can rotate the nth arm and the (n+1)th arm with respect to the base is realized and the robot is installed in the cell not by the nth arm but by installation of the base in the cell, and thus, the installation work of the robot in the cell may be easily performed.

### BRIEF DESCRIPTION OF THE DRAWINGS

The invention will be described with reference to the accompanying drawings, wherein like numbers reference like elements.

FIG. 1 is a perspective view showing the first embodiment of a robot system according to the invention.

FIG. 2 is a perspective view of a robot of the robot system shown in FIG. 1.

FIG. 3 is a schematic diagram of the robot of the robot system shown in FIG. 1.

FIG. 4 shows the robot in a front view of the robot system shown in FIG. 1.

FIG. 5 shows the robot in the front view of the robot system shown in FIG. 1.

FIG. 6 shows the robot in the front view of the robot system shown in FIG. 1.

FIGS. 7A to 7E are diagrams for explanation of actions in work of the robot of the robot system shown in FIG. 1.

FIG. 8 is a diagram for explanation of an action in work of the robot of the robot system shown in FIG. 1.

FIG. 9 is a diagram for explanation of an action in work of the robot of the robot system shown in FIG. 1.

FIG. 10 is a diagram for explanation of an action in work of the robot of the robot system shown in FIG. 1.

FIG. 11 is a diagram for explanation of an action in work of the robot of the robot system shown in FIG. 1.

FIG. 12 is a perspective view showing the second embodiment of the robot system according to the invention.

FIG. 13 shows a robot in a front view of the robot system shown in FIG. 12.

FIG. 14 is a perspective view showing the third embodiment of the robot system according to the invention.

FIG. 15 shows a robot in a front view of the robot system shown in FIG. 14.

### DESCRIPTION OF EXEMPLARY EMBODIMENTS

Hereinafter, a robot system according to the invention will be explained in detail based on preferred embodiments shown in the accompanying drawings.

### First Embodiment

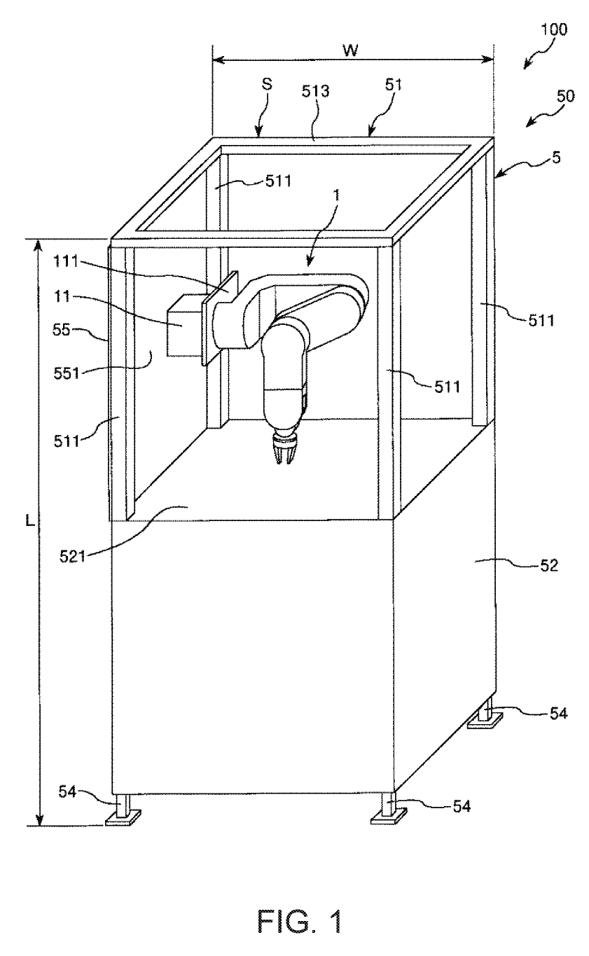

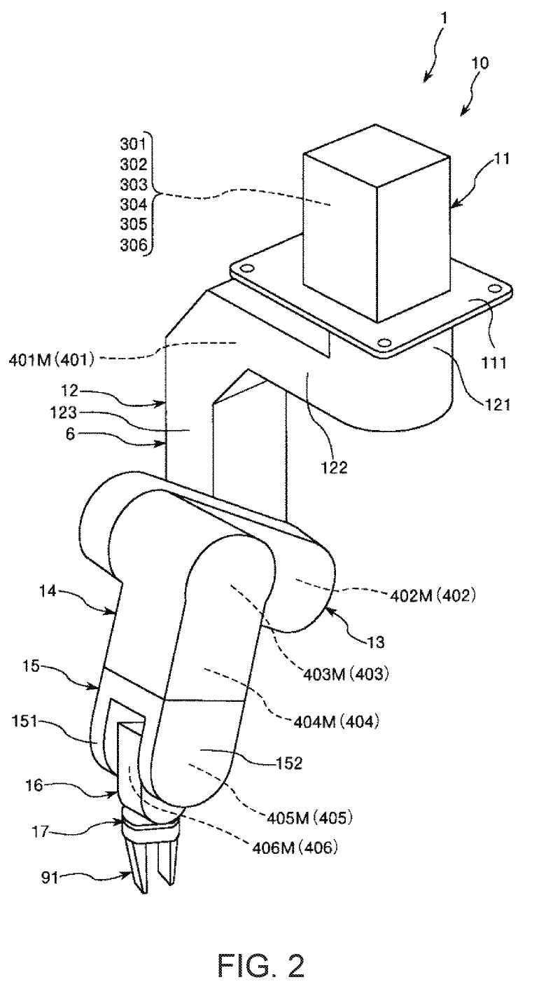

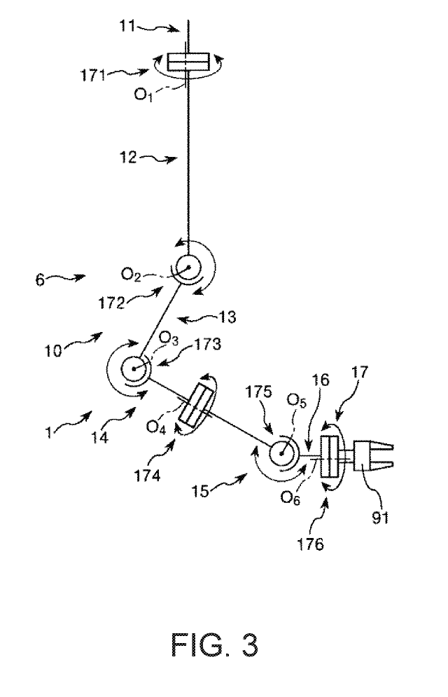

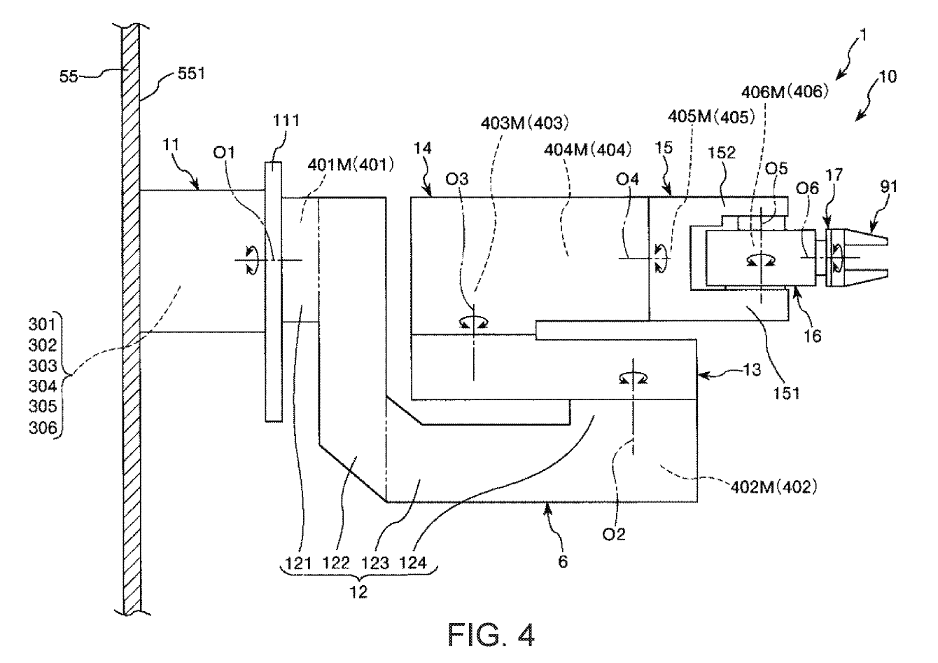

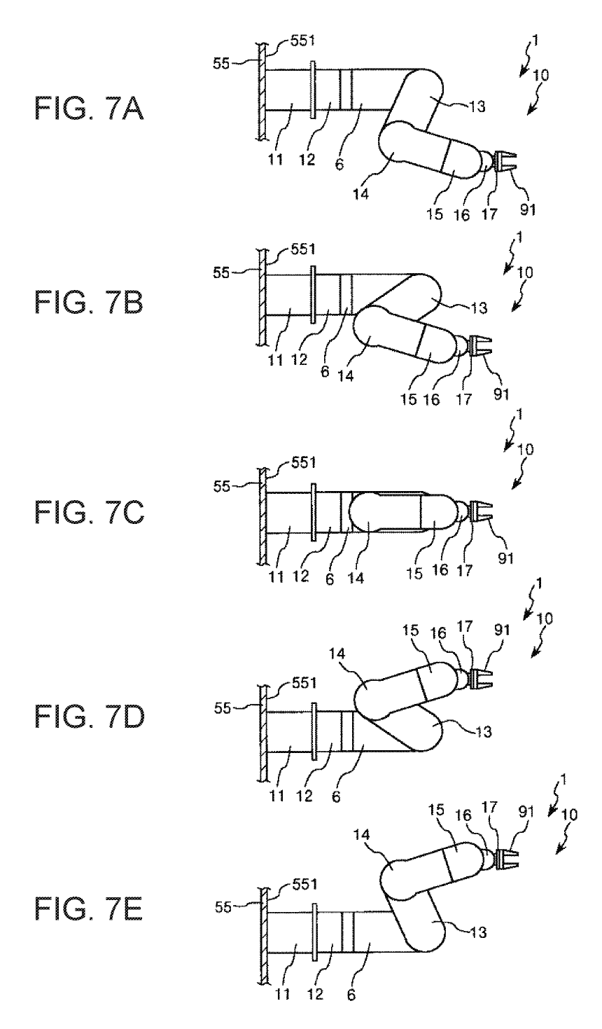

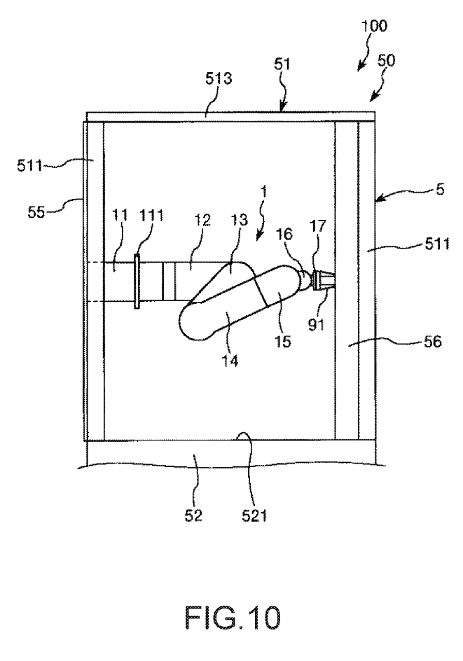

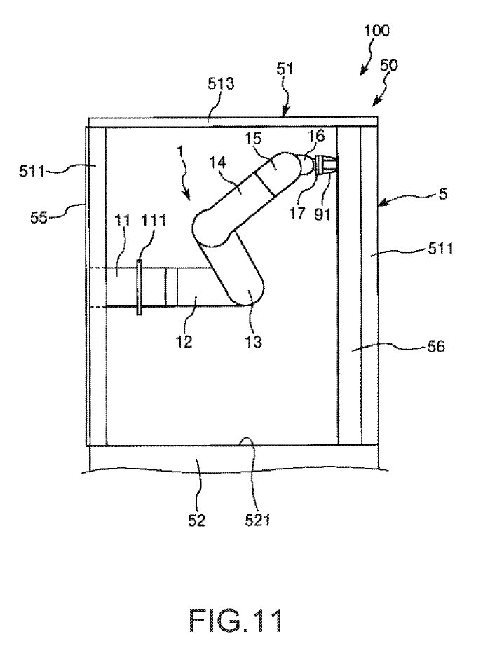

FIG. 1 is a perspective view showing the first embodiment of a robot system according to the invention. FIG. 2 is a perspective view of a robot of the robot system shown in FIG. 1. FIG. 3 is a schematic diagram of the robot of the robot system shown in FIG. 1. FIGS. 4 to 6 respectively show the robot in front views of the robot system shown in FIG. 1. FIGS. 7A to 11 are diagrams for explanation of actions in work of the robot of the robot system shown in FIG. 1.

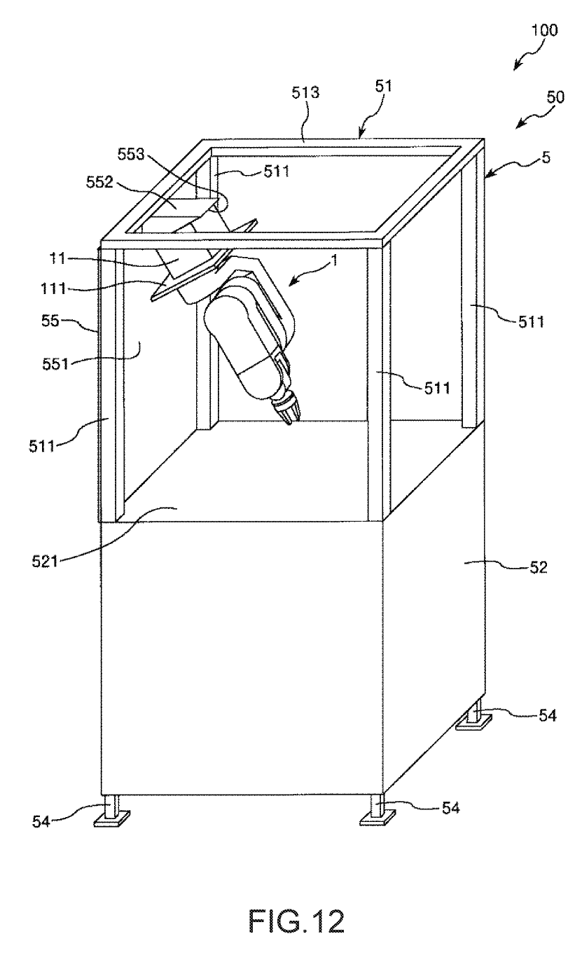

Hereinafter, for convenience of explanation, an upside in FIGS. 1, 4 to 11 is referred to as “up” or “upper” and a downside is referred to as “low” or “lower” (the same applies to FIGS. 12 to 14 of the other embodiments). Further, a base side in FIGS. 1 to 11 is referred to as “proximal end” or “upstream” and an opposite side (hand side) is referred to as “distal end” or “downstream” (the same applies to FIGS. 12 to 14 of the other embodiments). Furthermore, upward and downward directions in FIGS. 1, 4 to 11 are vertical directions (the same applies to FIGS. 12 to 14 of the other embodiments). In FIGS. 1 and 2, the robot not installed within a cell is shown.

A robot system 100 shown in FIG. 1 includes a robot cell 50 having a cell 5 and a robot (industrial robot) 1 provided within the cell 5. The robot 1 includes a robot main body (main body unit) 10 and a robot control apparatus (control unit) (not shown) that controls operation of the robot main body 10 (robot 1).

For example, the robot system 100 may be used in a manufacturing process of manufacturing precision apparatuses such as wristwatches or the like. Further, for example, the robot 1 may perform respective work of feeding, removing, carrying, and assembly of the precision apparatuses and parts forming the apparatuses.

Note that the robot control apparatus may be provided within the cell 5 or outside of the cell 5. When the robot control apparatus is provided within the cell 5, the robot control apparatus may be provided inside of the robot main body 10 (robot 1) or separated from the robot main body 10. The robot control apparatus may be formed using e.g. a personal computer (PC) containing a CPU (Central Processing Unit) or the like.

### Cell

As shown in FIG. 1, the cell 5 is a member that surrounds (houses) the robot 1, and easily relocated. Within the cell 5, mainly, the robot 1 performs work of assembly or the like.

The cell 5 has four foot parts 54 for installation of the entire cell 5 in an installation space on e.g. a floor or the like, a frame body part 51 supported by the four foot parts 54, a workbench (bench part) 52 provided in the lower part of the frame body part 51, and a wall part 55 provided in the upper part of the frame body part 51 than the workbench 52 on one side surface (the left side surface in FIG. 1) of the frame body part 51. The outer shape of the cell 5 when the cell 5 is seen from the vertical direction is not particularly limited, and square in the embodiment. The outer shape may be e.g. a rectangular shape or the like.

The frame body part 51 has four pillars 511 extending in the vertical directions (upward and downward directions in FIG. 1), and a frame-shaped upper portion 513 provided on the upper ends of the four pillars 511.

The workbench 52 has a rectangular parallelepiped shape in the embodiment and has square (rectangular) plate bodies on its six surfaces. The four corners of the workbench 52 are supported by the four pillars 511 of the frame body part 51 as seen from the vertical direction. The robot 1 may perform respective work on a work surface 521 of the workbench 52.

The wall part 55 is a member that supports the robot 1 and has a square (rectangular) plate shape in the embodiment. Two sides of the wall part 55 are placed on the two pillars 511. A base 11 of the robot 1, which will be described later, is fixed (supported) to an inner wall surface (first surface) 551 of the wall part 55. The wall surface 551 is a flat surface forming a different angle from that by the horizontal plane, and a flat surface perpendicular to the horizontal plane in the embodiment.

Incidentally, between the adjacent pillars 511 upper than the workbench 52, i.e., the other three side surfaces of the frame body part 51 and the upper portion 513, safety plates (not shown) or the like may be respectively provided for preventing workers and foreign matter such as dust from entering the frame body part 51.

The cell 5 does not necessarily have the foot parts 54. In this case, the workbench 52 may be directly installed in the installation space.

### Robot

As shown in FIGS. 2 to 4, the robot main body 10 has the base (support unit) 11 and a robot arm 6. The robot arm 6 includes a first arm (first arm member) (arm part) 12, a second arm (second arm member) (arm part) 13, a third arm (third arm member) (arm part) 14, a fourth arm (fourth arm member) (arm part) 15, a fifth arm (fifth arm member) (arm part) 16, and a sixth arm (sixth arm member) (arm part) 17 (six arms), and a first drive source 401, a second drive source 402, a third drive source 403, a fourth drive source 404, a fifth drive source 405, and a sixth drive source 406 (six drive sources). The fifth arm 16 and the sixth arm 17 form a wrist and, for example, an end effector such as a hand 91 may be detachably attached to the distal end of the sixth arm 17.

The robot 1 is a vertical articulated (six-axis) robot in which the base 11, the first arm 12, the second arm 13, the third arm 14, the fourth arm 15, the fifth arm 16, and the sixth arm 17 are coupled in this order from the proximal end side toward the distal end side. As below, the first arm 12, the second arm 13, the third arm 14, the fourth arm 15, the fifth arm 16, and the sixth arm 17 will be respectively also referred to as “arm”. The first drive source 401, the second drive source 402, the third drive source 403, the fourth drive source 404, the fifth drive source 405, and the sixth drive source 406 will be respectively also referred to as “drive source”.

As shown in FIGS. 1 and 4, the base 11 is apart fixed (a member attached) to the wall surface 551 of the wall part 55 of the cell 5. The fixing method is not particularly limited, e.g. a fixing method using a plurality of bolts or the like may be employed.

Further, in the embodiment, the distal end surface of the base 11 (the left end surface in FIG. 4) is attached to the wall surface 551, however, the attachment location of the base 11 to the wall surface 551 is not limited to that. For example, the location may be a plate-like flange 111 provided on the distal end of the base 11.

Note that the base 11 may include a joint 171, which will be described later, or not (see FIG. 3).

Furthermore, the first arm 12, the second arm 13, the third arm 14, the fourth arm 15, the fifth arm 16, and the sixth arm 17 are respectively supported to be independently displaceable with respect to the base 11.

As shown in FIGS. 2 to 4, the first arm 12 has a bending shape. In the explanation of the state in FIG. 4, the first arm 12 is connected to the base 11 and has a first portion 121 extending from the base 11 in a shaft direction of a first rotation shaft O1 (horizontal direction), which will be described later, toward the right side in FIG. 4, a second portion 122 extending from the right end of the first portion 121 in FIG. 4 in a shaft direction of a second rotation shaft O2 toward the downside in FIG. 4, a third portion 123 provided on an opposite end of the second portion 122 to the first portion 121 and extending in the shaft direction of the first rotation shaft O1 toward the right side in FIG. 4, and a fourth portion 124 extending from an opposite end of the third portion 123 to the second portion 122 in the shaft direction of the second rotation shaft O2 (vertical direction) toward the upside in FIG. 4. These first portion 121, second portion 122, third portion 123, and fourth portion 124 are integrally formed. Further, the second portion 122 and the third portion 123 are nearly orthogonal (cross) as seen from a direction orthogonal to both the first rotation shaft O1 and the second rotation shaft O2 (as seen from the near side of the paper surface of FIG. 4).

The second arm 13 has a longitudinal shape and is connected to the distal end of the first arm 12, i.e., the opposite end of the fourth portion 124 to the third portion 123.

The third arm 14 has a longitudinal shape and is connected to the distal end of the second arm 13, i.e., the opposite end of the second arm 13 to the end to which the first arm 12 is connected.

The fourth arm 15 is connected to the distal end of the third arm 14, i.e., the opposite end of the third arm 14 to the end to which the second arm 13 is connected. The fourth arm 15 has a pair of supporting parts 151, 152 opposed to each other. The supporting parts 151, 152 are used for connection of the fourth arm 15 to the fifth arm 16.

The fifth arm 16 is located between the supporting parts 151, 152 and connected to the supporting parts 151, 152, and thereby, coupled to the fourth arm 15.

The sixth arm 17 has a flat plate shape and is connected to the proximal end of the fifth arm 16. Further, for example, the hand 91 that grasps a precision apparatus such as a wristwatch, a part, or the like is detachably attached to the distal end of the sixth arm 17 (the opposite end to the fifth arm 16) as the end effector. Driving of the hand 91 is controlled by the robot control apparatus. The hand 91 includes, but not particularly limited to, e.g. a configuration having a plurality of finger portions (fingers). The robot 1 controls the actions of the arms 12 to 17 etc. while grasping a precision apparatus, a part, or the like with the hand 91, and thereby, may perform respective work of carrying the precision apparatus, the part, or the like.

As shown in FIGS. 2 to 4, the base 11 and the first arm 12 are coupled via the joint 171. The joint 171 has a mechanism that rotatably supports the first arm 12 with respect to the base 11, which are coupled to each other. Thereby, the first arm 12 is rotatable around the first rotation shaft O1 in parallel to the horizontal direction (about the first rotation shaft O1) with respect to the base 11. The first rotation shaft O1 is aligned with a normal of the wall surface 551 of the wall part 55 to which the base 11 is attached. Further, the first rotation shaft O1 is a rotation shaft on the most upstream side of the robot 1. The rotation about the first rotation shaft O1 is performed by driving of the first drive source 401 having a motor 401M. Further, the first drive source 401 is driven by the motor 401M and a cable (not shown), and the motor 401M is controlled by the robot control apparatus via a motor driver 301 electrically connected thereto. Note that the first drive source 401 may be adapted to transmit the drive power from the motor 401M by a reducer (not shown) provided with the motor 401M, or the reducer may be omitted.

The first arm 12 and the second arm 13 are coupled via a joint 172. The joint 172 has a mechanism that rotatably supports one of the first arm 12 and the second arm 13 coupled to each other with respect to the other. Thereby, the second arm 13 is rotatable around the second rotation shaft O2 in parallel to the vertical direction (about the second rotation shaft O2) with respect to the first arm 12. The second rotation shaft O2 is orthogonal to the first rotation shaft O1. The rotation about the second rotation shaft O2 is performed by driving of the second drive source 402 having a motor 402M. Further, the second drive source 402 is driven by the motor 402M and a cable (not shown), and the motor 402M is controlled by the robot control apparatus via a motor driver 302 electrically connected thereto. Note that the second drive source 402 may be adapted to transmit the drive power from the motor 402M by a reducer (not shown) provided with the motor 402M, or the reducer may be omitted. The second rotation shaft O2 may be parallel to the shaft orthogonal to the first rotation shaft O1, or the second rotation shaft O2 may be different in shaft direction from the first rotation shaft O1, not orthogonal thereto.

The second arm 13 and the third arm 14 are coupled via a joint 173. The joint 173 has a mechanism that rotatably supports one of the second arm 13 and the third arm 14 coupled to each other with respect to the other. Thereby, the third arm 14 is rotatable around the third rotation shaft O3 in parallel to the vertical direction (about the third rotation shaft O3) with respect to the second arm 13. The third rotation shaft O3 is parallel to the second rotation shaft O2. The rotation about the third rotation shaft O3 is performed by driving of the third drive source 403. Further, the third drive source 403 is driven by a motor 403M and a cable (not shown), and the motor 403M is controlled by the robot control apparatus via a motor driver 303 electrically connected thereto. Note that the third drive source 403 may be adapted to transmit the drive power from the motor 403M by a reducer (not shown) provided with the motor 403M, or the reducer may be omitted.

The third arm 14 and the fourth arm 15 are coupled via a joint 174. The joint 174 has a mechanism that rotatably supports one of the third arm 14 and the fourth arm 15 coupled to each other with respect to the other. Thereby, the fourth arm 15 is rotatable around the fourth rotation shaft O4 in parallel to the center axis direction of the third arm 14 (about the fourth rotation shaft O4) with respect to the third arm 14 (base 11). The fourth rotation shaft O4 is orthogonal to the third rotation shaft O3. The rotation about the fourth rotation shaft O4 is performed by driving of the fourth drive source 404. Further, the fourth drive source 404 is driven by a motor 404M and a cable (not shown), and the motor 404M is controlled by the robot control apparatus via a motor driver 304 electrically connected thereto. Note that the fourth drive source 404 may be adapted to transmit the drive power from the motor 404M by a reducer (not shown) provided with the motor 404M, or the reducer may be omitted. The fourth rotation shaft O4 may be parallel to the shaft orthogonal to the third rotation shaft O3, or the fourth rotation shaft O4 may be different in shaft direction from the third rotation shaft O3, not orthogonal thereto.

The fourth arm 15 and the fifth arm 16 are coupled via a joint 175. The joint 175 has a mechanism that rotatably supports one of the fourth arm 15 and the fifth arm 16 coupled to each other with respect to the other. Thereby, the fifth arm 16 is rotatable around the fifth rotation shaft O5 orthogonal to the center axis direction of the fourth arm 15 (about the fifth rotation shaft O5) with respect to the fourth arm 15. The fifth rotation shaft O5 is orthogonal to the fourth rotation shaft O4. The rotation about the fifth rotation shaft O5 is performed by driving of the fifth drive source 405. Further, the fifth drive source 405 is driven by a motor 405M and a cable (not shown), and the motor 405M is controlled by the robot control apparatus via a motor driver 305 electrically connected thereto. Note that the fifth drive source 405 may be adapted to transmit the drive power from the motor 405M by a reducer (not shown) provided with the motor 405M, or the reducer may be omitted. The fifth rotation shaft O5 may be parallel to the shaft orthogonal to the fourth rotation shaft O4, or the fifth rotation shaft O5 may be different in shaft direction from the fourth rotation shaft O4, not orthogonal thereto.

The fifth arm 16 and the sixth arm 17 are coupled via a joint 176. The joint 176 has a mechanism that rotatably supports one of the fifth arm 16 and the sixth arm 17 coupled to each other with respect to the other. Thereby, the sixth arm 17 is rotatable around the sixth rotation shaft O6 (about the sixth rotation shaft O6) with respect to the fifth arm 16. The sixth rotation shaft O6 is orthogonal to the fifth rotation shaft O5. The rotation about the sixth rotation shaft O6 is performed by driving of the sixth drive source 406. Further, the sixth drive source 406 is driven by a motor 406M and a cable (not shown), and the motor 406M is controlled by the robot control apparatus via a motor driver 306 electrically connected thereto. Note that the sixth drive source 406 may be adapted to transmit the drive power from the motor 406M by a reducer (not shown) provided with the motor 406M, or the reducer may be omitted. The sixth rotation shaft O6 may be parallel to the shaft orthogonal to the fifth rotation shaft O5, or the sixth rotation shaft O6 may be different in shaft direction from the fifth rotation shaft O5, not orthogonal thereto.

As above, the configuration of the robot 1 is briefly explained.

Next, the relationships among the first arm 12 to the sixth arm 17 will be explained, and the explanation will be made from various viewpoints while the expressions etc. are changed. Further, the third arm 14 to the sixth arm 17 are considered in a condition that they are stretched straight, i.e. longest, in other words, in a condition that the fourth rotation shaft O4 and the sixth rotation shaft O6 are aligned or in parallel.

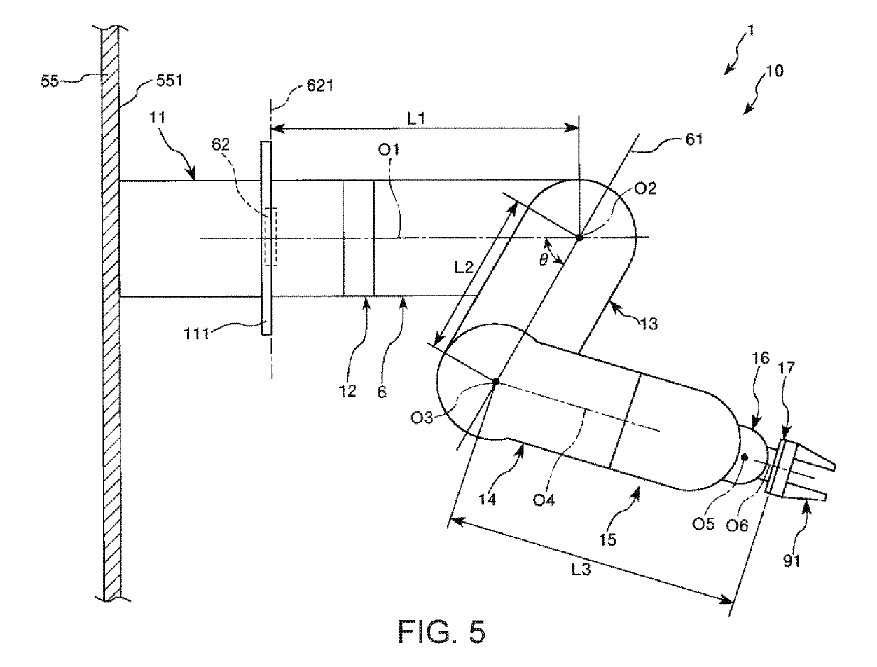

First, as shown in FIG. 5, a length L1 of the first arm 12 is set to be longer than a length L2 of the second arm 13.

Here, the length L1 of the first arm 12 is a distance between the second rotation shaft O2 and a center line 621 extending in the vertical directions in FIG. 5 of a bearing part 62 that rotatably supports the first arm 12 as seen from the shaft direction of the second rotation shaft O2.

Further, the length L2 of the second arm 13 is a distance between the second rotation shaft O2 and the third rotation shaft O3 as seen from the shaft direction of the second rotation shaft O2.

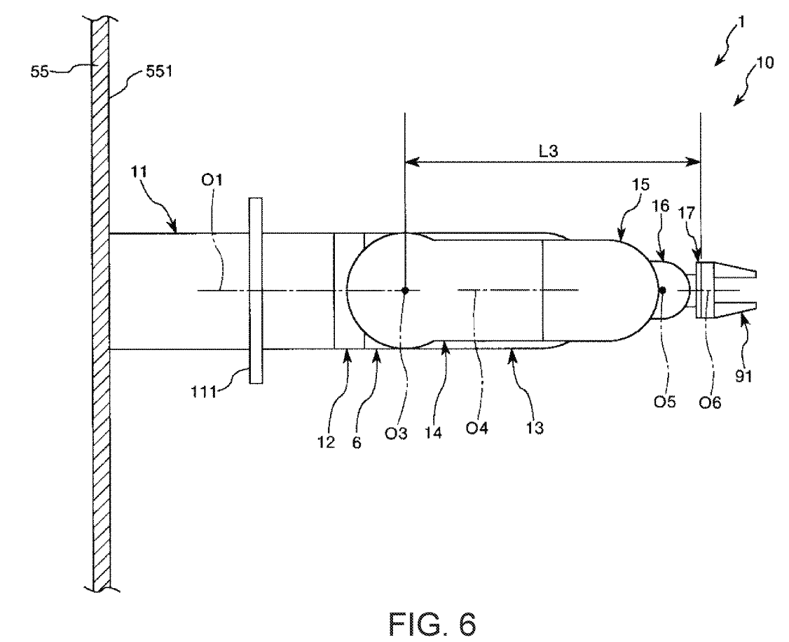

Further, as shown in FIG. 6, an angle θ formed between the first arm 12 and the second arm 13 may be adapted to be 0° as seen from the shaft direction of the second rotation shaft O2. That is, the first arm 12 and the second arm 13 may be adapted to overlap as seen from the shaft direction of the second rotation shaft O2.

When the angle θ is 0°, i.e., the first arm 12 and the second arm 13 overlap as seen from the shaft direction of the second rotation shaft O2, the second arm 13 is adapted not to interfere with the wall surface 551 of the wall part 55 on which the base 11 is provided or the second portion 122 of the first arm 12. Similarly, when the flange 111 is attached to the wall surface 551, the second arm 13 is adapted not to interfere with the wall surface 551 and the second portion 122 of the first arm 12.

Here, the angle θ formed by the first arm 12 and the second arm 13 is an angle formed by a straight line passing through the second rotation shaft O2 and the third rotation shaft O3 (a center axis of the second arm 13 as seen from the shaft direction of the second rotation shaft O2) 61 and the first rotation shaft O1 as seen from the shaft direction of the second rotation shaft O2.

The distal end of the second arm 13 can be moved to a position different by 180° about the first rotation shaft O1 through a state in which the angle θ is 0° as seen from the shaft direction of the second rotation shaft O2 by rotation of the second arm 13 without rotation of the first arm 12 (the first arm 12 and the second arm 13 overlap) (see FIGS. 7A to 7E). That is, by rotation of the second arm 13 without rotation of the first arm 12, the distal end of the robot arm 6 (the distal end of the sixth arm 17) can be moved from a first position shown in FIG. 7A through the state in which the angle θ is 0° to a second position shown in FIG. 7E different by 180° about the first rotation shaft O1 (see FIGS. 7A to 7E). Note that the third arm 14 to the sixth arm 17 are respectively rotated as appropriate.

When the distal end of the second arm 13 is moved to the position different by 180° about the first rotation shaft O1 (when the distal end of the robot arm 6 is moved from the first position to the second position), the distal end of the second arm 13 and the distal end of the robot arm 6 move on a straight line as seen from the shaft direction of the first rotation shaft O1.

Further, a total length L3 of the third arm 14 to the sixth arm 17 is set to be longer than the length L2 of the second arm 13.

Thereby, as seen from the shaft direction of the second rotation shaft O2, when the second arm 13 and the third arm 14 are overlapped, the distal end of the sixth arm 17 may be protruded from the second arm 13. Thereby, the hand 91 may be prevented from interfering with the first arm 12 and the second arm 13.

Here, the total length L3 of the third arm 14 to the sixth arm 17 is a distance between the third rotation shaft O3 and the distal end of the sixth arm 17 as seen from the shaft direction of the second rotation shaft O2 (see FIG. 5). In this case, regarding the third arm 14 to the sixth arm 17, the fourth rotation shaft O4 and the sixth rotation shaft O6 are aligned or in parallel as shown in FIG. 5.

Further, as shown in FIG. 6, the second arm 13 and the third arm 14 are adapted to overlap as seen from the shaft direction of the second rotation shaft O2.

That is, as seen from the shaft direction of the second rotation shaft O2, the first arm 12, the second arm 13, and the third arm 14 are adapted to overlap at the same time.

In the robot 1, the above described relationships are satisfied, and thereby, by rotation of the second arm 13 and the third arm 14 without rotation of the first arm 12, the hand 91 (the distal end of the sixth arm 17) may be moved to a position different by 180° about the first rotation shaft O1 through the state in which the angle θ formed by the first arm 12 and the second arm 13 is 0° (the first arm 12 and the second arm 13 overlap) as seen from the shaft direction of the second rotation shaft O2. The robot 1 may be efficiently driven using the action, the space provided for preventing the robot 1 from interfering may be reduced, and the following various advantages are obtained.

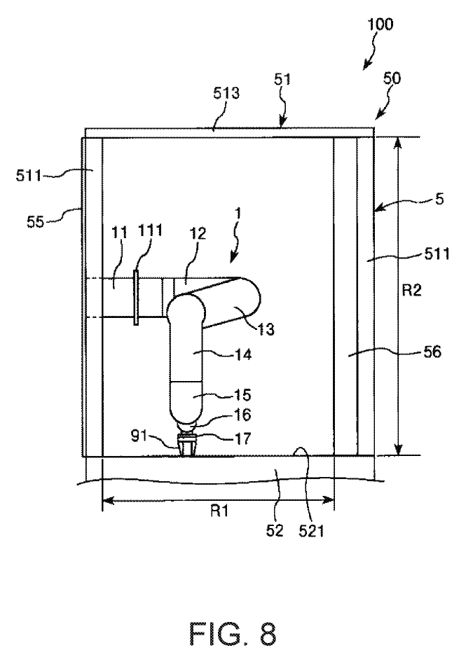

Next, examples of work of feeding, removing, carrying, and assembly and actions of the robot 1 at the work will be explained. In this case, as shown in FIG. 8, a work plate 56 is installed on a side surface opposed to the wall part 55 within the cell 5.

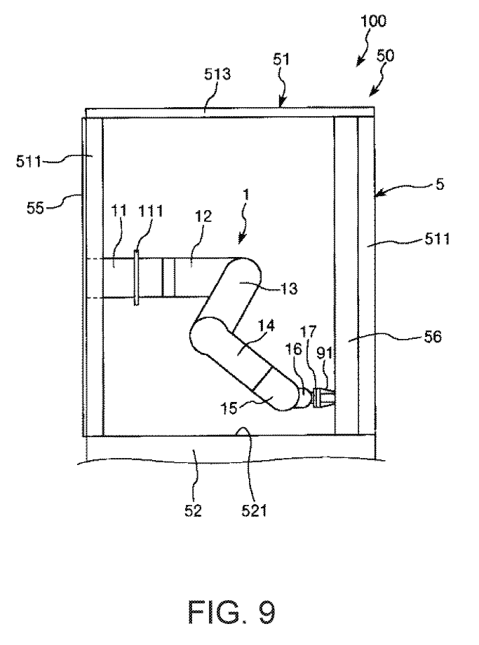

As shown in FIG. 8, the robot 1 grasps a predetermined part (not shown) placed on the workbench 52 with the hand 91, and carries the part to a predetermined position of the work plate 56 as shown in FIGS. 9 to 11. Further, the robot 1 carries the part from the predetermined position of the work plate 56 to another predetermined position of the work plate 56 with the hand 91.

In this case, as shown in FIGS. 7A, 7B, 7C, 7D, 7E, the robot 1 does not rotate the first arm 12 but rotates the second arm 13 and the third arm 14 and a necessary arm of the fourth arm 15 to the sixth arm 17, and thereby, may move the hand 91 to the position different by 180° about the first rotation shaft O1 through the state in which the angle θ formed by the first arm 12 and the second arm 13 is 0° (the first arm 12 and the second arm 13 overlap) as seen from the shaft direction of the second rotation shaft O2 (see FIG. 7C). In this regard, the distal end of the second arm 13 and the hand 91 (the distal end of the sixth arm 17) move on a straight line. Further, in this regard, the first arm 12 may be rotated as appropriate.

The robot 1 may move the hand 91 in the entire of a region R1 of the workbench 52, and may move the hand 91 in the entire of a region R2 of the work plate 56.

Further, the robot 1 has the above described configuration, and the installation space of the robot 1, i.e., the cell 5 may be made smaller than that in related art. Thereby, the area of the installation space for installation of the cell 5 (installation area), i.e., the area S of the cell 5 when the cell 5 is seen from the vertical direction may be made smaller than that in related art. Specifically, the area S may be reduced to e.g. 64% of the area in related art or less. Accordingly, the width of the cell 5 (the length of one side in the horizontal direction) W may be made smaller than that in related art, specifically, e.g. 80% of the width in related art or less. Note that, as described above, in the embodiment, the cell 5 as seen from the vertical direction has a square shape and the width (depth) W of the cell 5 in the longitudinal direction in FIG. 1 and the width (lateral width) W of the cell 5 in the lateral direction in FIG. 1 are the same, however, they may be different. In this case, one or both of the widths W may be reduced to e.g. 80% of the area in related art or less.

Specifically, the area S is preferably less than 637500 mm², more preferably 500000 mm² or less, even more preferably 400000 mm² or less, and particularly preferably 360000 mm² or less. Even the area S may prevent the robot 1 from interfering with the cell 5 when the distal end of the second arm 13 is moved to a position different by 180° about the second rotation shaft. Accordingly, the cell 5 may be downsized and the installation space for installation of the robot system 100 may be made smaller. Therefore, for example, when the manufacturing line is formed by arrangement of a plurality of robot cells 50, the longer length of the production line may be suppressed.

Particularly, the area S of 400000 mm² or less is nearly equal to or less than the size of the work area in which a human works. Accordingly, when the area S is 400000 mm² or less, for example, replacement of a human by the robot cell 50 may be easily performed, and thus, the manufacturing line may be changed by replacement of the human by the robot cell 50. Note that the area S is preferably 10000 mm² or more. Thereby, the maintenance inside of the robot cell 50 may be easily performed.

Specifically, the width W is preferably less than 850 mm, more preferably less than 750 mm, and even more preferably 650 mm or less. Thereby, the same advantages as the above described advantages may be sufficiently exerted. Note that the width W is an average width of the cells 5 (an average width of the frame body parts 51). Note that the width W is preferably 100 mm or more. Thereby, the maintenance inside of the robot cell 50 may be easily performed.

The robot 1 has the above described configuration, and the height of the cell 5 (the length in the vertical direction) L may be made lower than the height in related art. Specifically, the height L may be reduced to e.g. 80% of the height in related art or less.

Further, specifically, the height L is preferably 1700 mm or less, more preferably from 1000 mm to 1650 mm. When the height is equal to or less than the upper limit, the influence of the vibration when the robot 1 acts within the cell 5 may be further suppressed. The height L is an average height of the cells 5 including the foot parts 54.

As described above, in the robot system 100, the position of the center of gravity of the robot 1 is lower and the influence of the vibration of the robot 1 may be made smaller than those in the case where the robot 1 is installed on the ceiling surface of the cell. That is, the vibration generated by the reaction force due to the action of the robot 1 may be suppressed. Further, the robot 1 itself being an obstacle may be suppressed compared to the case where the robot 1 is installed on the floor surface of the cell, and workability of the robot 1 within the cell 5 may be improved.

The robot 1 may move the hand 91 (the distal end of the robot arm 6) to the position different by 180° about the first rotation shaft O1 through the state in which the angle θ formed by the first arm 12 and the second arm 13 is 0° (the first arm 12 and the second arm 13 overlap) as seen from the shaft direction of the second rotation shaft O2 by rotation of the second arm 13 and the third arm 14 or the like without rotation of the first arm 12, and the space for preventing the robot 1 from interfering may be made smaller. Thereby, the cell 5 may be downsized and the installation space for installation of the robot system 100 may be made smaller. Further, for example, the larger number of robot systems 100 per unit length may be provided along a production line, and the production line may be shortened.

When the hand 91 is moved, the movement of the robot 1 may be made smaller. For example, the first arm 12 may not be moved or the rotation angle of the first arm 12 may be made smaller, and thereby, the takt time may be shortened and the work efficiency may be improved.

### Second Embodiment

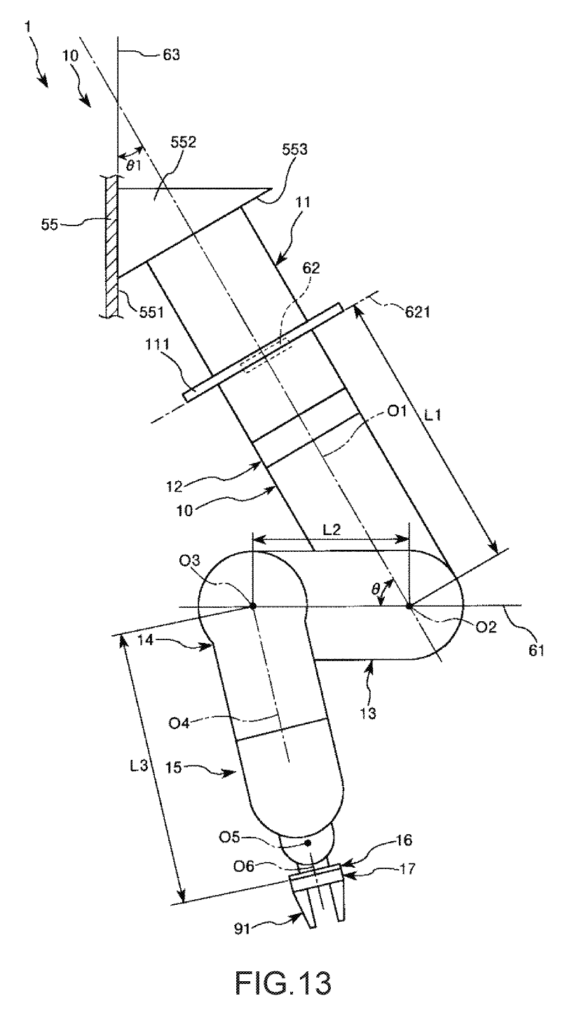

FIG. 12 is a perspective view showing the second embodiment of the robot system according to the invention. FIG. 13 shows a robot in a front view of the robot system shown in FIG. 12.

As below, the second embodiment will be explained and the explanation will be made with focus on differences from the above described first embodiment and the explanation of the same items will be omitted.

As shown in FIGS. 12 and 13, in the robot system 100 of the second embodiment, an attachment part 552 to which the base 11 of the robot 1 is attached is formed in the upper part in the vertical direction of the wall part 55 of the cell 5.

The shape of the attachment part 552 is not particularly limited, and is a triangular prism shape in the embodiment. Further, a surface 553 of the attachment part 552 directed obliquely downward in FIG. 12 and FIG. 13 is a first surface tilted with respect to the horizontal plane, and the base 11 is attached to the surface 553. Thereby, the first rotation shaft O1 of the robot 1 is tilted at a predetermined angle with respect to the vertical direction so that its distal end side may be located above the proximal end side in the vertical direction.

Thereby, the hand 91 (the distal end of the robot arm 6) may be moved to a farther position as seen from the vertical direction compared to the case where the shaft direction of the first rotation shaft O1 of the robot 1 is the vertical direction.

An angle θ1 formed by the first rotation shaft O1 and a straight line 63 extending in the vertical direction is equal to or more than 0° and less than 90°, preferably from 10° to 80° and more preferably from 20° to 45°.

The angle θ1 is set to be equal to or more than the lower limit, and thereby, the hand 91 may be moved to a farther position as seen from the vertical direction.

Further, the angle θ1 is set to be equal to or less than the upper limit, and thereby, the hand 91 may be moved to a farther position as seen from the horizontal direction compared to the case where the shaft direction of the first rotation shaft O1 of the robot 1 is the horizontal direction.

According to the second embodiment, the same advantages as those of the above described first embodiment may be exerted.

### Third Embodiment

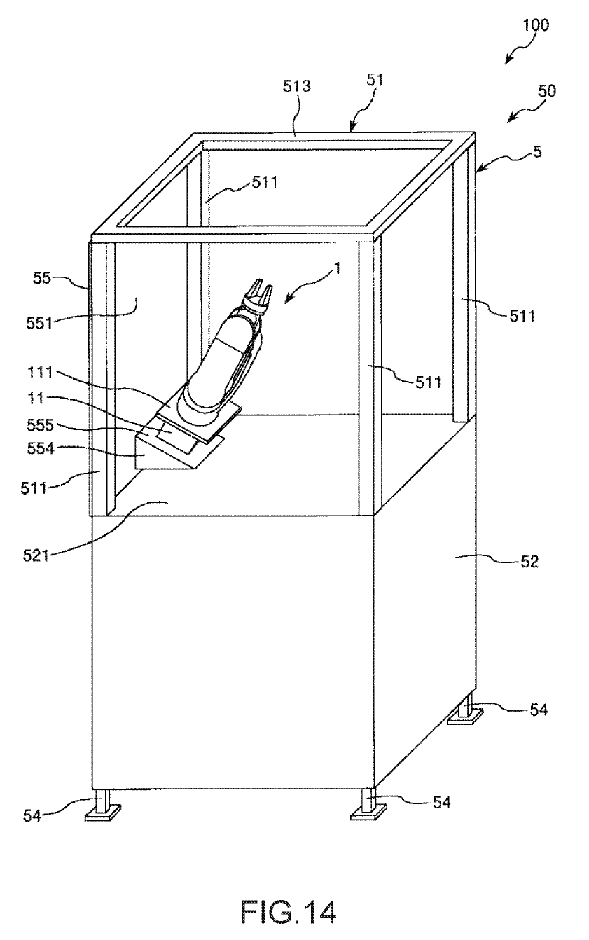

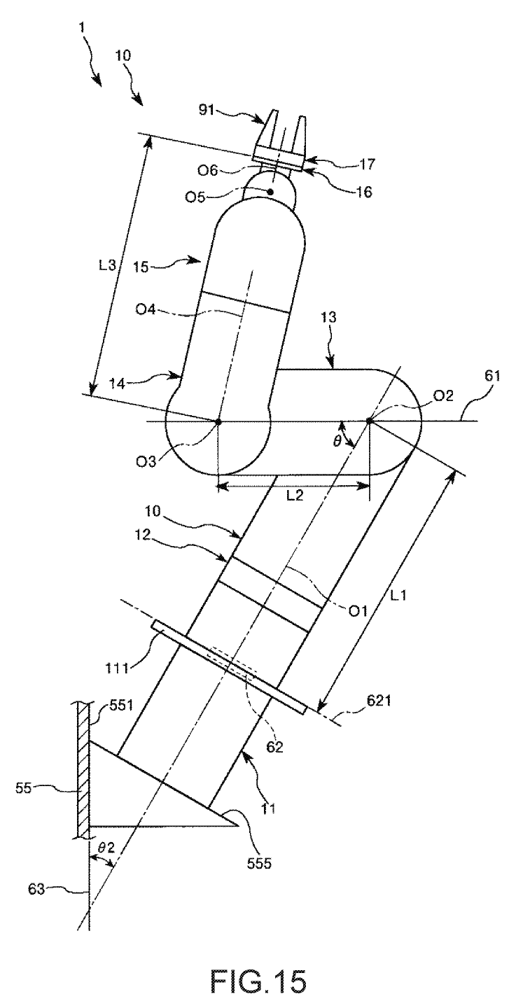

FIG. 14 is a perspective view showing the third embodiment of the robot system according to the invention. FIG. 15 shows a robot in a front view of the robot system shown in FIG. 14.

As below, the third embodiment will be explained and the explanation will be made with focus on differences from the above described first embodiment and the explanation of the same items will be omitted.

As shown in FIGS. 14 and 15, in the robot system 100 of the third embodiment, an attachment part 554 to which the base 11 of the robot 1 is attached is formed in the lower part in the vertical direction of the wall part 55 of the cell 5.

The shape of the attachment part 554 is not particularly limited, and is a triangular prism shape in the embodiment. Further, a surface 555 of the attachment part 554 directed obliquely upward in FIG. 14 and FIG. 15 is a first surface tilted with respect to the horizontal plane, and the base 11 is attached to the surface 555. Thereby, the first rotation shaft O1 of the robot 1 is tilted at a predetermined angle with respect to the vertical direction so that its distal end side may be located below the proximal end side in the vertical direction.

Thereby, the hand 91 (the distal end of the robot arm 6) may be moved to a farther position as seen from the vertical direction compared to the case where the shaft direction of the first rotation shaft O1 of the robot 1 is the vertical direction.

An angle θ2 formed by the first rotation shaft O1 and a straight line 63 extending in the vertical direction is equal to or more than 0° and less than 90°, preferably from 10° to 80° and more preferably from 20° to 45°.

The angle θ2 is set to be equal to or more than the lower limit, and thereby, the hand 91 may be moved to a farther position as seen from the vertical direction.

Further, the angle θ2 is set to be equal to or less than the upper limit, and thereby, the hand 91 may be moved to a farther position as seen from the horizontal direction compared to the case where the shaft direction of the first rotation shaft O1 of the robot 1 is the horizontal direction.

According to the third embodiment, the same advantages as those of the above described first embodiment may be exerted.

As above, the robot system according to the invention is explained according to the illustrated embodiments, however, the invention is not limited to those and the configurations of the respective parts may be replaced by arbitrary configurations having the same functions. Further, other arbitrary configurations may be added.

Further, the invention may include a combination of two or more arbitrary configurations (features) of the above described respective embodiments.

In the above described embodiments, the first arm is provided on the base, however, the invention is not limited to that. For example, the base may be omitted. In this case, the first arm is provided on the cell.

Further, in the above described embodiments, regarding conditions (relationships) of an nth rotation shaft, an nth arm, an (n+1)th rotation shaft, and an (n+1)th arm defined in the appended claims, the case where n is one, i.e., the case where the first rotation shaft, the first arm, the second rotation shaft, and the second arm satisfy the conditions is explained, however, the invention is not limited to that. The n may be an integer number of one or more, and the same conditions as those in the case where n is one may be satisfied with respect to an arbitrary integer number equal to or more than one. Therefore, for example, in the case where n is two, i.e., the second rotation shaft, the second arm, the third rotation shaft, and the third arm may satisfy the same conditions as those in the case where n is one, in the case where n is three, i.e., the third rotation shaft, the third arm, the fourth rotation shaft, and the fourth arm may satisfy the same conditions as those in the case where n is one, in the case where n is four, i.e., the fourth rotation shaft, the fourth arm, the fifth rotation shaft, and the fifth arm may satisfy the same conditions as those in the case where n is one, or, in the case where n is five, i.e., the fifth rotation shaft, the fifth arm, the sixth rotation shaft, and the sixth arm may satisfy the same conditions as those in the case where n is one.

Furthermore, in the above described embodiments, the number of rotation shafts of the robot arm is six, however, the invention is not limited to that. The number of rotation shafts of the robot arm may be e.g. two, three, four, five, or seven or more. That is, in the above described embodiments, the number of arms (links) is six, however, the invention is not limited to that. The number of arms may be e.g. two, three, four, five, or seven or more.

In the above described embodiments, the number of robot arms is one, however, the invention is not limited to that. The number of robot arms may be e.g. two or more. That is, the robot (robot main body) may be e.g. a multi-arm robot including a dual-arm robot.

Further, in the above described embodiments, as the robot, one example of the vertical articulated robots is taken for explanation, however, the invention is not limited to that. The robot may be a vertical articulated robot having another structure.

In the invention, the robot (robot main body) may be a robot in another form. A specific example includes e.g. a legged walking (running) robot having leg parts or the like.

The entire disclosure of Japanese Patent Application No. 2015-071199, filed Mar. 31, 2015 is expressly incorporated by reference herein.

What is claimed is:

1. A robot system comprising:
a cell having a first surface at an angle different from that of a horizontal plane; and
a robot provided on the first surface,
wherein the robot has an nth (n is an integer number equal to or more than one) arm rotatable about an nth rotation shaft, and an (n+1)th arm provided on the nth arm rotatably about an (n+1)th rotation shaft in a shaft direction different from a shaft direction of the nth rotation shaft.

2. The robot system according to claim 1, wherein the first surface is perpendicular to the horizontal plane.

3. The robot system according to claim 1, wherein the first surface is tilted with respect to the horizontal plane.

4. The robot system according to claim 1, wherein a length of the nth arm is longer than a length of the (n+1)th arm, and the nth arm and the (n+1)th arm can overlap as seen from the shaft direction of the (n+1)th rotation shaft.

5. The robot system according to claim 4, wherein an installation area of the robot cell is less than 637500 mm².

6. The robot system according to claim 4, wherein an installation area of the robot cell is equal to or less than 500000 mm².

7. The robot system according to claim 1, wherein the robot has a base provided on the first surface, and
the n is one and the nth arm is provided on the base.
